(19) United States
(12) Patent Application Publication
(10) Pub. No.: US 2022/0005262 A1
(43) Pub. Date: Jan. 6, 2022

(54) SYSTEM AND METHOD FOR AN AUGMENTED REALITY BOATING AND FISHING APPLICATION

(71) Applicant: Clearview, Inc., Brookline, MA (US)

(72) Inventors: JOSHUA HONAKER, Brookline, MA (US); CHRIS MCROBBIE, Brookline, MA (US); DAVID ROSE, Brookline, MA (US); GEORGE WHITE, Brookline, MA (US); JOSHUA JACOBS, Brookline, MA (US); MADELEINE FOUGERE, Brookline, MA (US); MICHAEL LEONARDO, Brookline, MA (US)

(73) Assignee: Clearview, Inc., Brookline, MA (US)

(21) Appl. No.: 17/353,159

(22) Filed: Jun. 21, 2021

Related U.S. Application Data
(60) Provisional application No. 63/102,840, filed on Jul. 6, 2020.

(51) Int. Cl. G06T 15/20; G06T 19/00; G06F 16/29; G06N 20/00

(52) U.S. Cl. CPC G06T 15/205; G06T 19/003; G06T 2215/16; G06F 16/29; G06N 20/00; G06T 19/006

(57) ABSTRACT

An augmented reality boating and fishing system includes a client device comprising a client application, a computing system comprising a server-based application and a database datastore comprising topobathy data that are presented as data elevation model (DEM) data of a water body. The client application accesses the server-based application and the database datastore via a network connection. The server-based application includes an augmented reality (AR) engine, a computing algorithm, and a rendering engine. The AR engine receives the DEM data of the water body and environmental factor inputs and uses the computing algorithm to calculate fish probability distributions of various types of fish within the water body. The rendering engine fuses the calculated fish probability distributions and DEM data and generates an AR composite image that is viewed via the client device.

### CROSS REFERENCE TO RELATED CO-PENDING APPLICATIONS

This application claims the benefit of U.S. provisional application Ser. No. 63/102,840 filed on Jul. 7, 2020 and entitled “CleAR Water: an augmented reality boating and fishing application”, which is commonly assigned and the contents of which are expressly incorporated herein by reference.

### FIELD OF THE INVENTION

The present invention relates to a system and a method for an augmented reality boating and fishing application, and more particularly to a system and a method for creating the illusion of seeing through water to discern the landscape or topobathy of a lake or ocean to guide anglers and boaters.

### BACKGROUND OF THE INVENTION

Typical marine electronic equipment provide GPS 2D-maps, sonar detectors, weather applications, environmental parameter sensors, position and orientation sensors, and navigation applications, among others. Boater may also use their mobile phones to access GPS 2D-map data, fish-finding applications, weather applications, environmental parameters, and position orientation data, among others. However, in spite of the availability of these expensive marine electronic equipment, and the existing fishing applications and data, it takes a lot of expertise and effort to combine the existing 2D-maps with the fishing applications and to predict where is a good place to fish. Even after undertaking such a combination of 2D-mapping data with fishing application, it is still difficult to visualize in 3D where exactly the fish is within the water. Accordingly, there is a need for a fishing application that displays a 3D topographical map receding downwards into a body of water together with the types of fish that can be fished in the specific body of water.

### SUMMARY OF THE INVENTION

The present invention provides a system and a method for an augmented reality boating and fishing application, and more particularly to a system and a method for creating the illusion of seeing through water to discern the landscape or topobathy of a lake or ocean to guide anglers and boaters.

In general, in one aspect the invention provides a system for an augmented reality boating and fishing application including a client device comprising a client application, a computing system comprising a server-based application and a database datastore comprising topobathy data that are presented as data elevation model (DEM) data of a water body. The client application accesses the server-based application and the database datastore via a network connection. The server-based application includes an augmented reality (AR) engine, a computing algorithm, and a rendering engine. The AR engine receives the DEM data of the water body and environmental factor inputs and uses the computing algorithm to calculate fish probability distributions of various types of fish within the water body. The rendering engine fuses the calculated fish probability distributions and DEM data and generates an AR composite image that is viewed via the client device.

Implementations of this aspect of the invention include the following. The AR composite image is superimposed onto a user's field of view and displayed via a user interface of the client application. The client device includes a camera and the composite image is superimposed onto a user's field of view, as viewed via the camera. The client device may be a tablet, a mobile phone or smart glasses. The environmental factors may be at least one of terrain gradients, water visibility, water temperature, tide, wind, current, barometric pressure, light intensity, time of day, date, seasonal variations, local noise, and local traffic. The computing algorithm calculates the fish probability distributions of various types of fish within the water body using the environmental factors and set rules and machine-learned rules based on historical data about which species of fish prefer which combinations of the environmental factors. The rendering engine receives external data including instantaneous location GPS data, 5G inputs, orientation compass data and gyroscope data. The AR composite image includes the topobathy and bathymetry mapping data, the calculated fish probability distributions, fish location markers, water temperature data, suggested cast depth and suggested fishing equipment and techniques, animated flora and fauna simulated under the water surface in 3D, waypoint and navigation paths between waypoints to optimize fish yield, visualization of boating hazards and navigation dangers. The client application includes a user interface that provides options to drop markers for fishing suggestions, for boating hazards and custom markers within the displayed AR composite image. The client application includes a user interface that provides options to capture digital images, video clips and audio clips of the AR composite image, fish, hazards and objects in the water and upload these digital images, video clips and audio clip to an online website. The client application includes a user interface that provides options to project markers above the surface of the water body within the displayed AR composite image.

In general, in another aspect the invention provides a computer-implemented method for an augmented reality boating and fishing application including the following. Providing a client device comprising a client application. Providing a computing system comprising a server-based application. Providing a database datastore comprising topobathy data that are presented as data elevation model (DEM) data of a water body. The server-based application comprises and augmented reality (AR) engine, a computing algorithm, and a rendering engine. Next, receiving the DEM data of the water body and environmental factor inputs by the AR engine and using the computing algorithm to calculate fish probability distributions of various types of fish within the water body. Next, fusing the calculated fish probability distributions and DEM data by the rendering engine and generating an AR composite image that is viewed via the client device. The client application accesses the server-based application and the database datastore via a network connection.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an overview diagram of a system for an augmented reality boating and fishing application, according to this invention;

FIG. 2 depicts a mobile phone user interface displaying the generated composite image with the boating and fishing application of this invention within the camera's field of view;

FIG. 3 depicts the display of the generated composite image within the user's field of view, as viewed with smart glasses;

FIG. 4 depicts an example of the generated composite image with the boating and fishing application of this invention, according to this invention;

FIG. 5 depicts another example of the generated composite image with the boating and fishing application of this invention, according to this invention;

FIG. 6 depicts an example of the generated composite image with the boating and fishing application of this invention, under different lighting conditions;

FIG. 7 depicts an example of the generated composite image with the boating and fishing application of this invention, showing bottom and surface markers within the water body;

FIG. 8 depicts an example of the generated composite image with the boating and fishing application of this invention, showing navigation markers within the water body and above the water body;

FIG. 9-FIG. 11 depict screenshots of the user interface of the ClearWater boating and fishing application according to this invention;

FIG. 12 depicts a flow diagram of a method for an augmented reality boating and fishing application, according to this invention;

FIG. 13 depicts a screenshot of a fishing social network website, according to this invention; and

FIG. 14 depicts a schematic diagram of a computing system used in the implementation of this invention.

### DETAILED DESCRIPTION OF THE INVENTION

The present invention provides a system and a method for an augmented reality boating and fishing application, and more particularly to a system and a method for creating a composite image that provides an illusion of seeing through water to discern the landscape or topobathy of a lake or ocean to guide anglers and boaters.

In one embodiment, the invention provides a system and a method that takes Lidar generated depth-map data, runs several image processing tools including proprietary algorithms to determine the probability distribution for finding fish of various types, then displays the results scaled and positioned over the surface of the water. The resulting effect is a color-coded topo-map receding downwards into a body of water, with meta-data that is relevant to boaters and anglers superimposed in space.

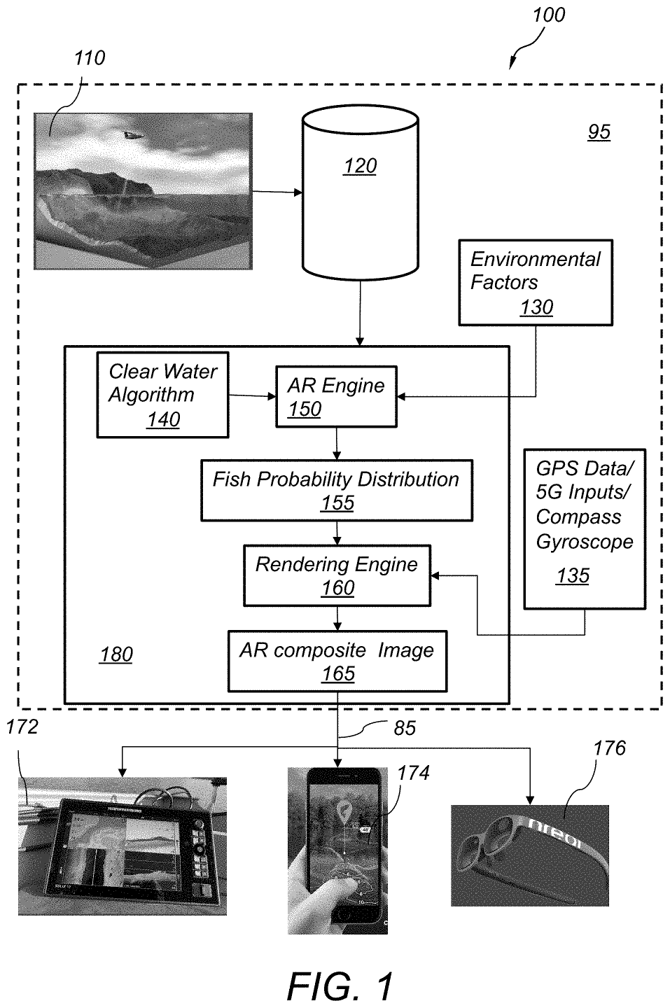

Referring to FIG. 1, a system 100 for creating a composite image that provides an illusion of seeing through water, includes a database 120, a computing system or a webserver 180, and client devices including a tablet 172, a mobile phone 174, and smart glasses 176 that connect to the webserver 180 via a network 85. Examples of a network connection 85 include wireless and wired networks that utilize hypertext markup language (HTML), simple object access protocol (SOAP) or representation state transfer (REST) on top of transmission control protocol (TCP) or user data protocol (UDP). The webserver 180 and the database system 120 are hosted on a cloud service environment 95.

Database 120 receives topobathy data 110 that are collected via airborne light detection and ranging (LiDAR) systems operating in a blue-green wavelength (532 μm) laser which penetrates through the water column. The same systems map terrestrial landscapes using a higher frequency to penetrate the foliage canopy of near-infrared wavelength (1000 μm-1500 μm). The resulting data are available from the National Oceanic and Atmospheric Administration (NOAA) and other private company sources in the form of a data elevation model (DEM) 110. These detailed depth contours 110 provide the size, shape, and distribution of underwater features including bottom sediment types for performing scientific, engineering, marine, geophysical, and environmental studies.

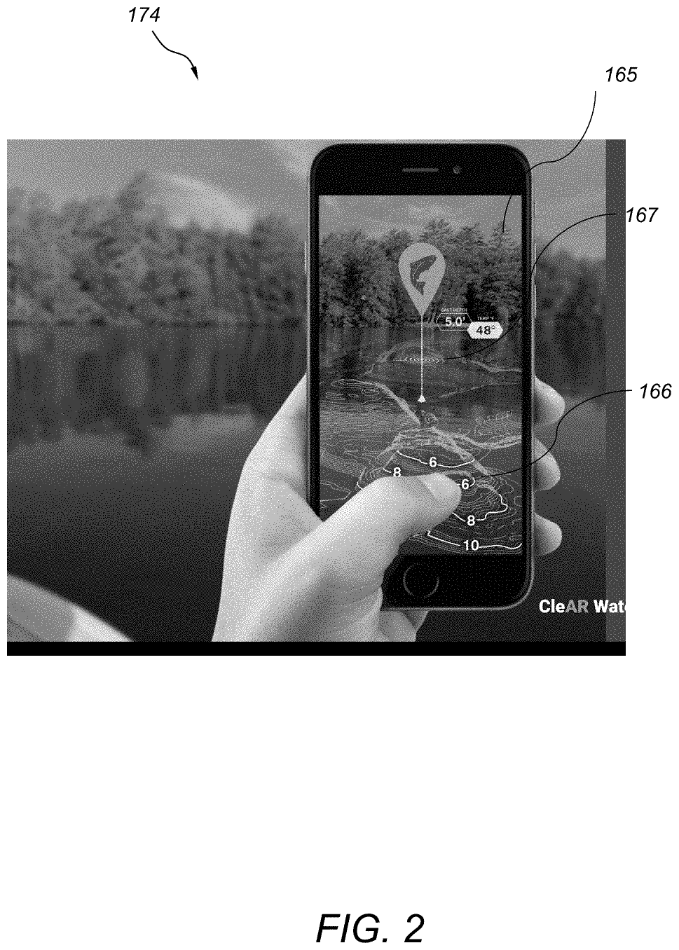

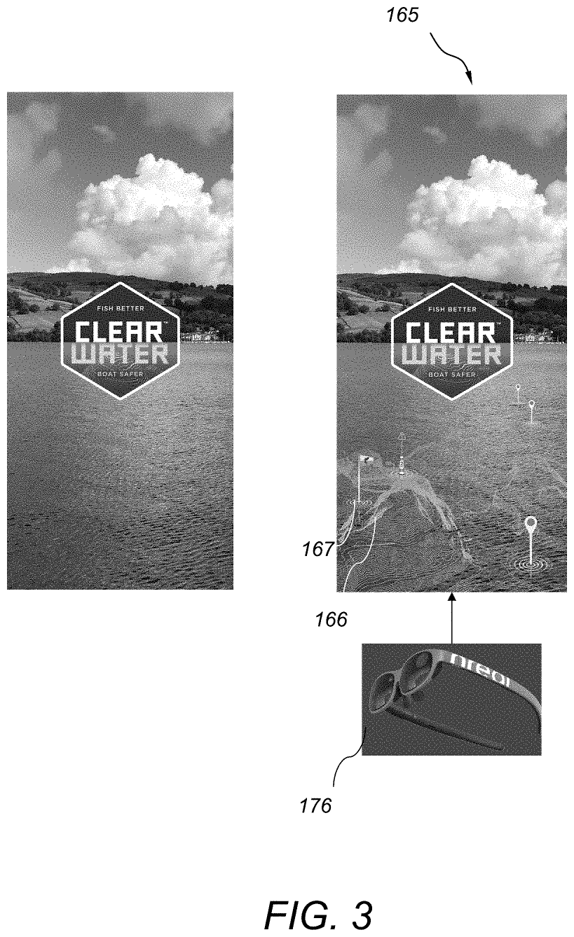

The computing system 180 includes an augmented reality (AR) engine 150, a ClearWater algorithm 140 and a rendering engine 165. The AR engine 150 receives the above mentioned terrain mapping data 110 and environmental factor inputs 130 and uses the ClearWater Algorithm 140 to calculate probability distributions of various types of fish 155. The environmental factor inputs 130 include terrain gradients, water visibility and temperature, tide, wind, current, and barometric pressure factors, light and time of day and seasonal variations, local factors like noise or traffic, among others. The ClearWater Algorithm 140 includes set rules and machine-learned rules based on historical data about which species of fish prefer which combinations of the above mentioned environmental factors. The calculated fish probability distributions 155 are entered into the rendering engine 160 together with external data 135 including instantaneous location GPS data, 5G inputs, and orientation compass and gyroscope data. The rendering engine 160 is capable of computing at least six degrees of freedom display including the above mentioned instantaneous location GPS data, 5G inputs, and orientation compass and gyroscope data. The rendering engine 160 generates an AR composite image that fuses the terrain mapping data 110 and the calculated fish probability distributions 155 and superimposes the composite image directly onto a user's field of view, as viewed via the camera of the tablet 172, or the camera of the mobile phone 174 or via the smart glasses 176. The user holds the camera of the tablet 172 or the mobile phone 174 in front of their eyes and views the generated AR composite image that includes the current field of view of the camera and the superimposed computer generated layers of the terrain mapping data 110 and the calculated fish probability distributions 155, as shown in FIG. 2. In the case of the smart glasses 176 that are worn by the user, the AR composite image 165 includes the current field of view of the user's eyes and the superimposed computer generated layers of the terrain mapping data 166 and the calculated fish probability distributions 167, as shown in FIG. 3. Examples of smart glasses include nReal, HoloLens, MagicLeap, and smart glasses from Apple, Google, Samsung, LG, among others.

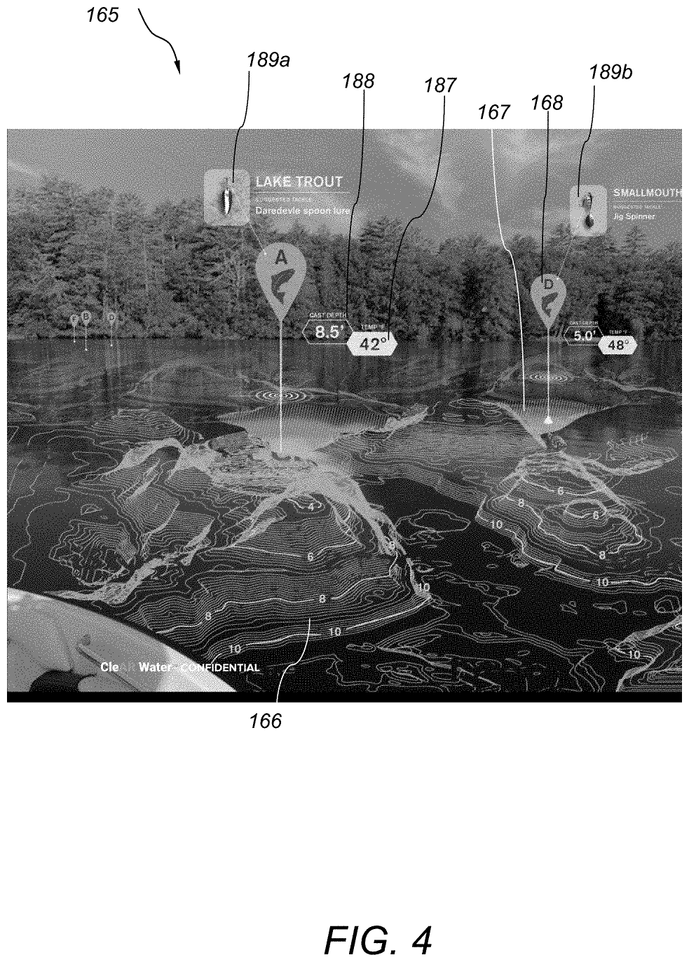

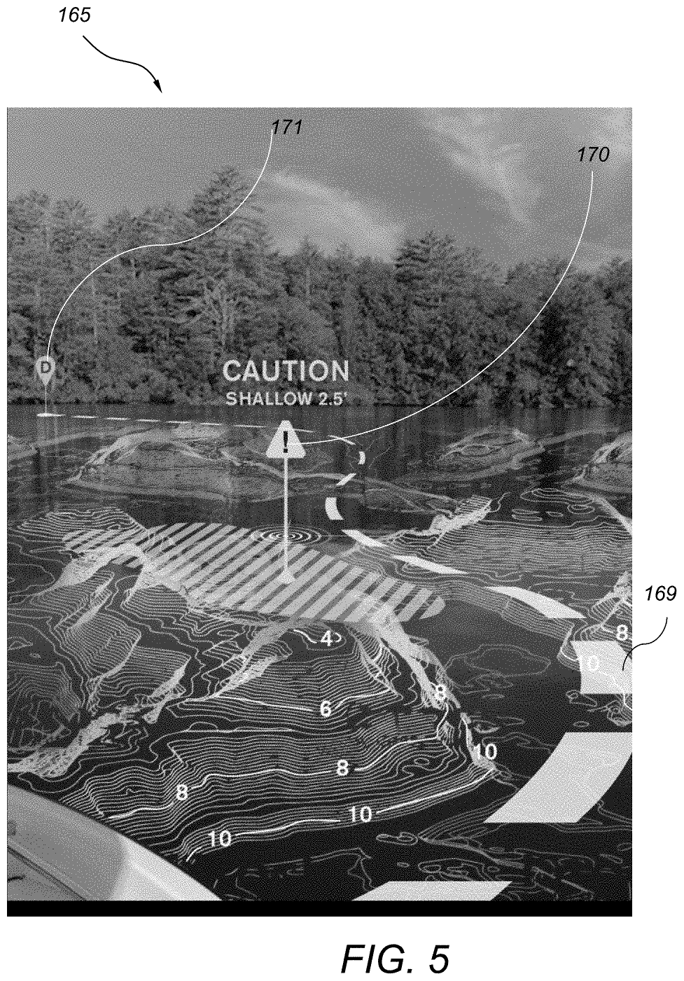

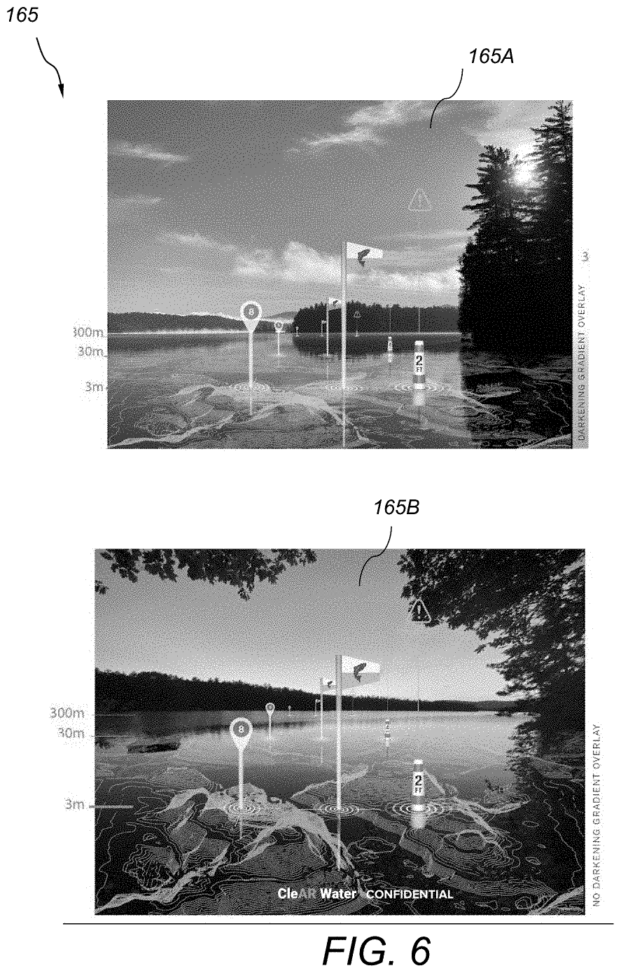

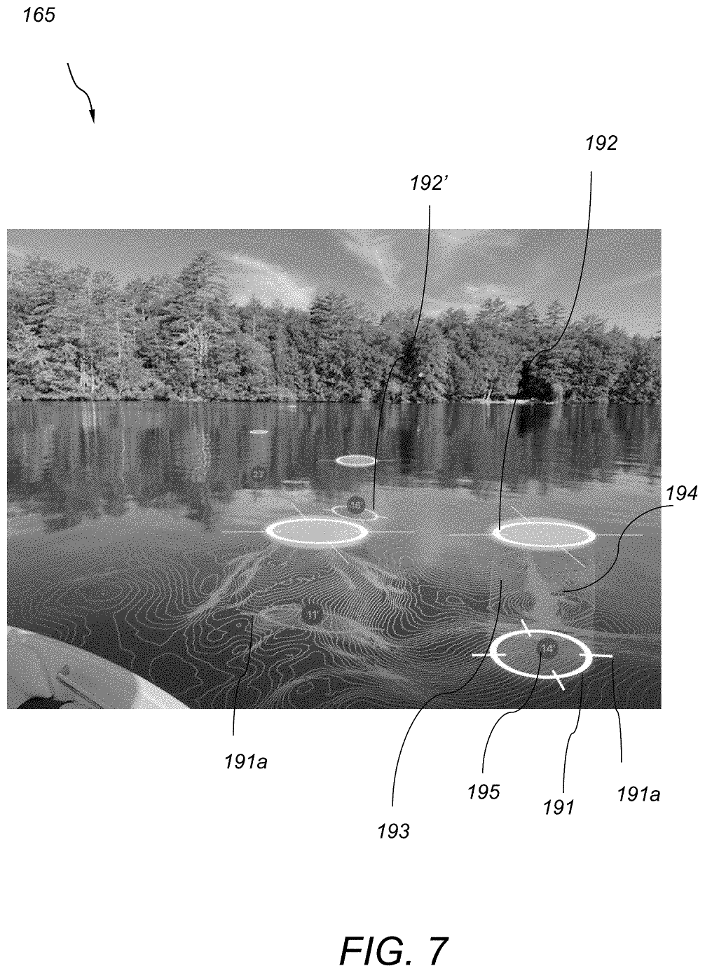

Referring to FIG. 4, and FIG. 5, the superimposed composite image 165 includes the bathymetry mapping data 166, the calculated fish probability distributions 167, fish location markers 168, water temperature 187, suggested cast depth 188 and suggested fishing equipment and techniques 189a, 189b, animated flora and fauna (aquatic life) simulated under the water surface in 3D, waypoints 171 and navigation paths 169 between waypoints to optimize fish yield, visualization of boating hazards and navigation dangers 170, among others. The visualized boating hazards and navigation dangers include wind vectors, shallow shoals, low tide risks, currents, and icebergs, among others. The bathymetry mapping data 166 include bathygraphy iso-bar lines indicating depth of the water and the calculated fish probability distributions 167 are displayed as heatmaps showing the probability of finding specific fish in a specific location and depth In one example, daredevle spoon lure is suggested for lake trout fishing 189a and jig spinner for smallmouth fishing 189b. The superimposed composite image 165 may be projected with a darkening gradient overlay or without, 165A, 165B, as shown in FIG. 6. In both cases, all markers, bathymetry maps and fish probability distribution lines are visible. In some embodiments, a first ring marker 191 is dropped at the bottom of the water body and a second ring marker 192 is set to float at surface of the water body above the area where the first marker sits, as shown in FIG. 7. The two markers define a water volume 193, and the distance 195 between the two markers 191, 192 shows the depth of the terrain in water volume 193. The bottom marker 191 is able to rotate and includes direction markers 191a extending from the periphery of the ring. The direction markers 191a orient themselves and point to the direction of the surface slope. The volume portion 194 where there is a high probability of finding fish is colored. Additional surface markers 192′ may be in the adjacent areas from surface marker 192 and their distance from markers 191 and 192 is indicated.

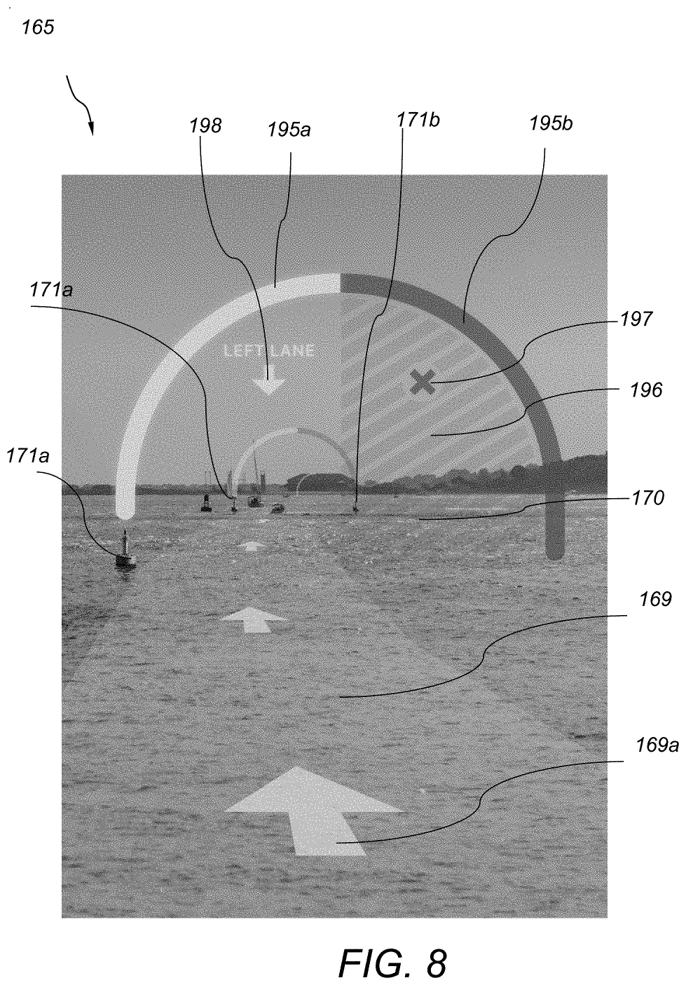

In the embodiment of FIG. 8, the side edges of a safe navigation path 169 are marked with in water green markers 171a and the side edges of an adjacent danger zone 170 are marked with in water red markers 171b Water surface green arrow markers 169a and above water projected green arc markers 195a and projected green arrows 198 indicate the areas and zones 169 that are safe to navigate through with a boat. The danger zone areas 170 are also marked with above water projected red arc markers 195b surrounding red hatched areas 196 above the water that also include a projected do not enter sign 197. These above water projected navigation markers 195a, 195b, 196, 197, 198, together with the in water navigation markers 171a, 171b are used for navigating through harbors or any other narrow passage through a water body.

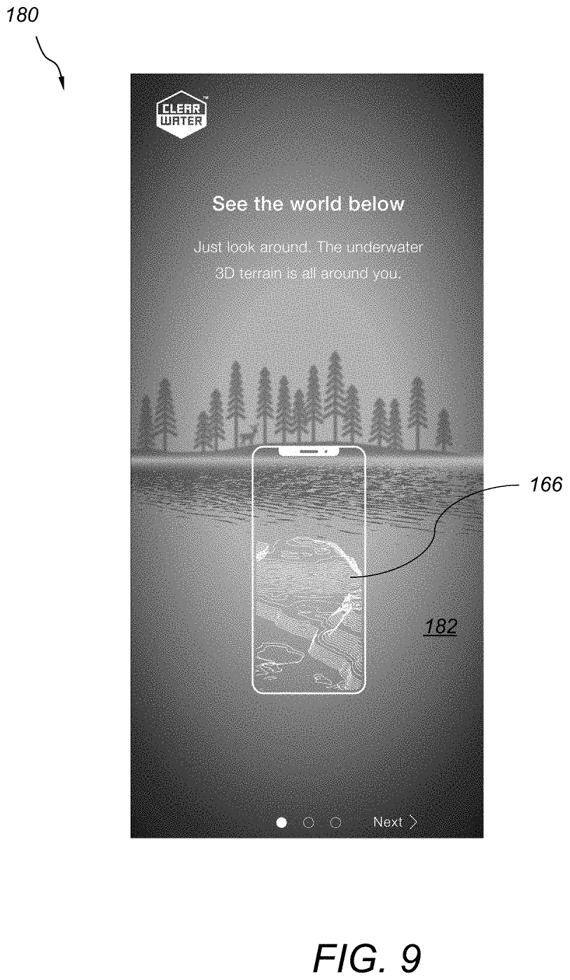

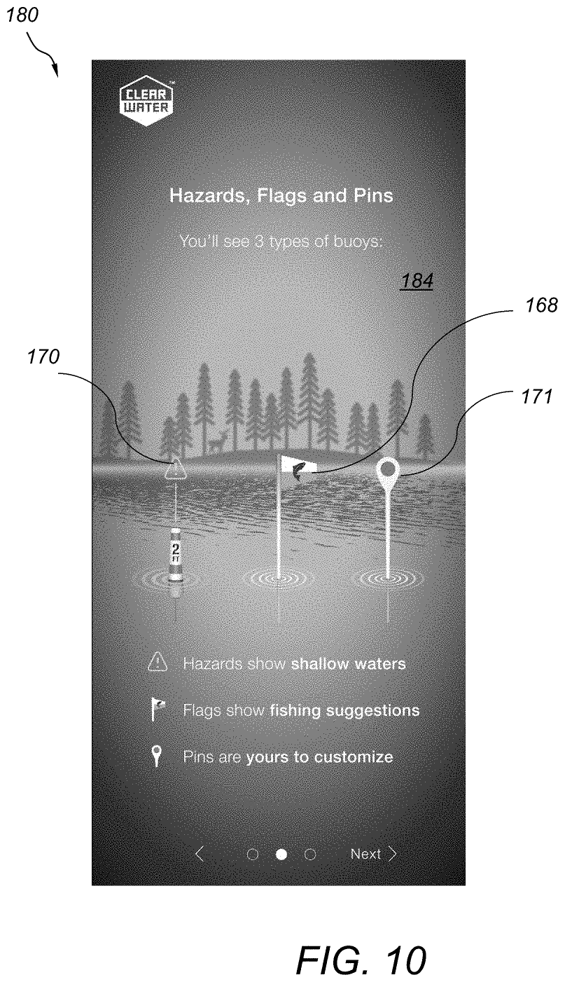

Referring to FIG. 9-FIG. 11, the ClearWater user interface (UI) 180 in the mobile phone 174 displays the bathymetry mapping data 166 and fish probability distribution data 167 when placed within the current field of view of the mobile phone camera (182). The UI 180 also provides the options to drop markers for fishing suggestions 168, for boating hazards 170 and custom markers 171 within the displayed composite image (184). Custom markers 171a, 171b, 171c marking the presence of an interesting structure in the water may be saved, shared and revisited at a future time (186).

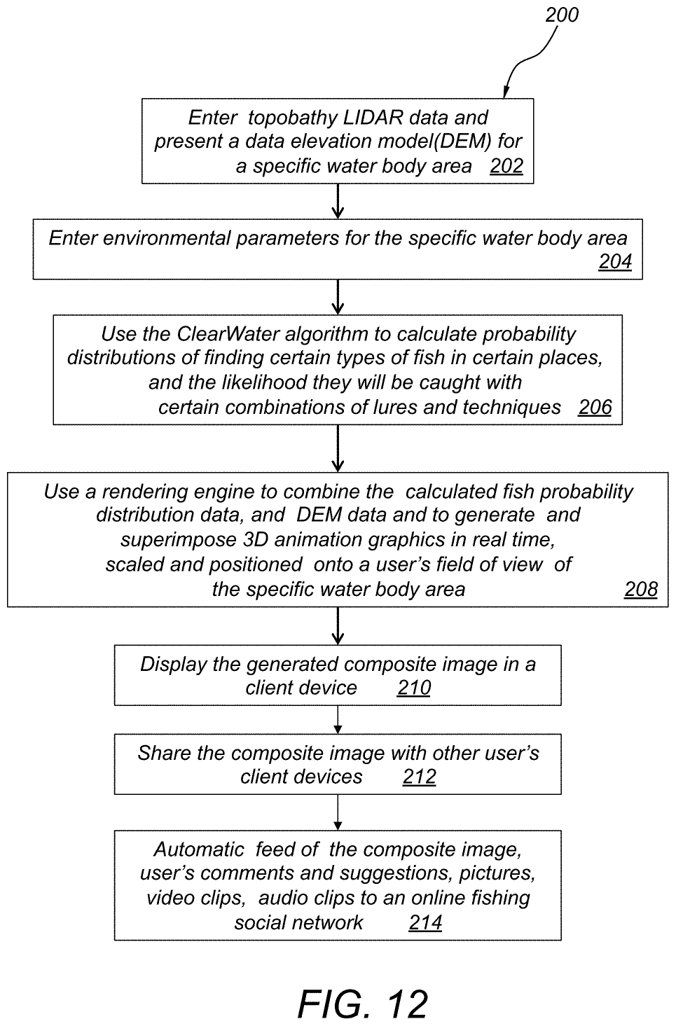

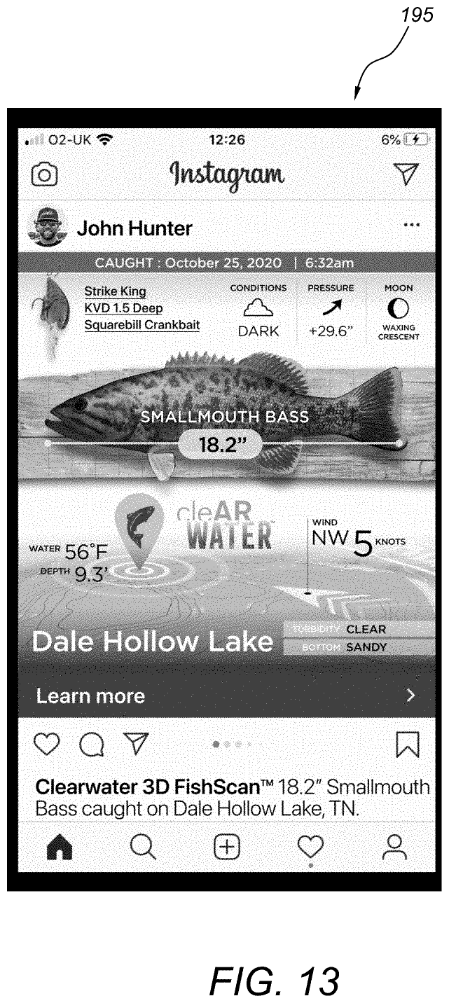

Referring to FIG. 12, the method 200 for creating a composite image that provides an illusion of seeing through water, includes the following step. First, we enter topobathy data and present a data elevation model (DEM) for a specific water body area (202). Next, we enter environmental parameters for the specific water body area (204). Examples of the environmental parameters 130 include terrain gradients, water visibility and temperature, tide, wind, current, and barometric pressure factors, light and time of day and seasonal variations, local factors like noise or traffic, among others. Next, we use the ClearWater algorithm to calculate probability distributions of finding certain types of fish in certain areas and depths of the water and the likelihood that the fish will be caught with certain combinations of lure and casting techniques (206). Next, we use a rendering engine to combine the calculated fish probability distribution data and DEM data and to generate and superimpose 3D animation graphics in real time scaled and positioned onto a user's field of view of the specific water body area (208). Next, we display the generated composite image in a client device (210). The users may share the generated composite images with other users' client devices (212). There may also be an automatic feed of the generated composite image to an online social network together with posting of comments and suggestion, and uploading of pictures, video clips and audio clips (214). The users may be fisherman, angles, boating captains, divers and underwater archaeologists and explorers, among others. The users may share images of the captured fish including date, time, location, environmental conditions, lure, fishing technique and description of size and number of fish, as shown in FIG. 13. In the example of FIG. 13, the fisherman caught a smallmouth bass on Oct. 25, 2020 at 6:32 am in Dale Hollow Lake, Tenn., using a Strike King KVD 1.5 Deep Squarebill Crankbait. The fish measured 18.2″ long. The environmental parameters are indicated including light, atmospheric pressure, moon phase, water temperature, depth, water turbidity, and bottom structure.

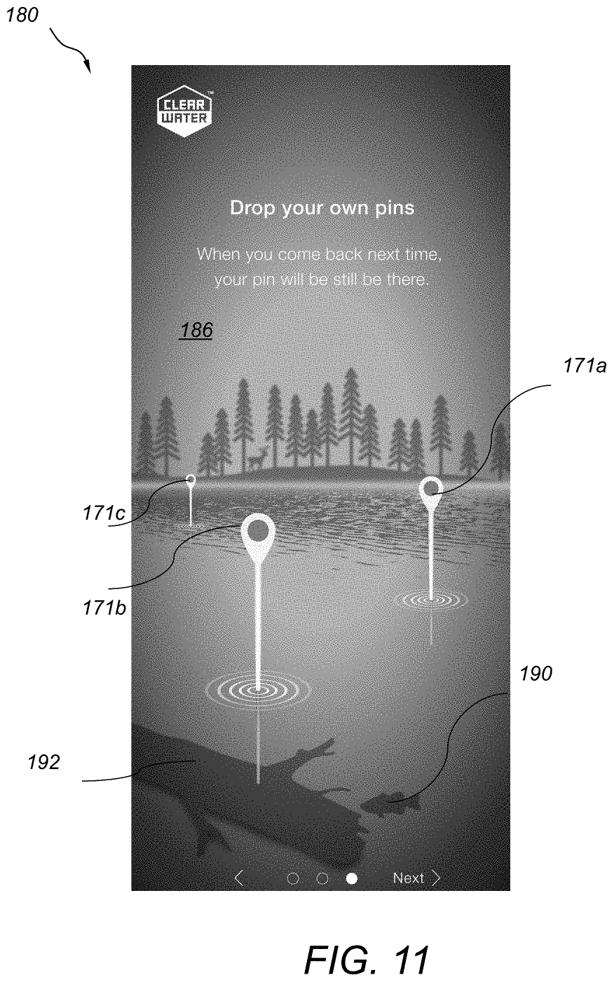

Other embodiments of the present invention include one or more of the following. A compass map on a gimbal is used for orientation over the water. A reticle is used to reveal the depth using a ray-cast in the center of the user's field of view. A sky dashboard is used to show where the points of interest are at a distance. The distance between the position of the user and the markers is indicated. After catching a fish, a 3D virtual model of the fish is generated and is added to swim in the imaged water as a “Ghost fish” 190, as shown in FIG. 11. A sunken item, such as a tree 192, ship, or archaeological artifact can be identified and “re-floated” from the sea-floor, as shown in FIG. 11.

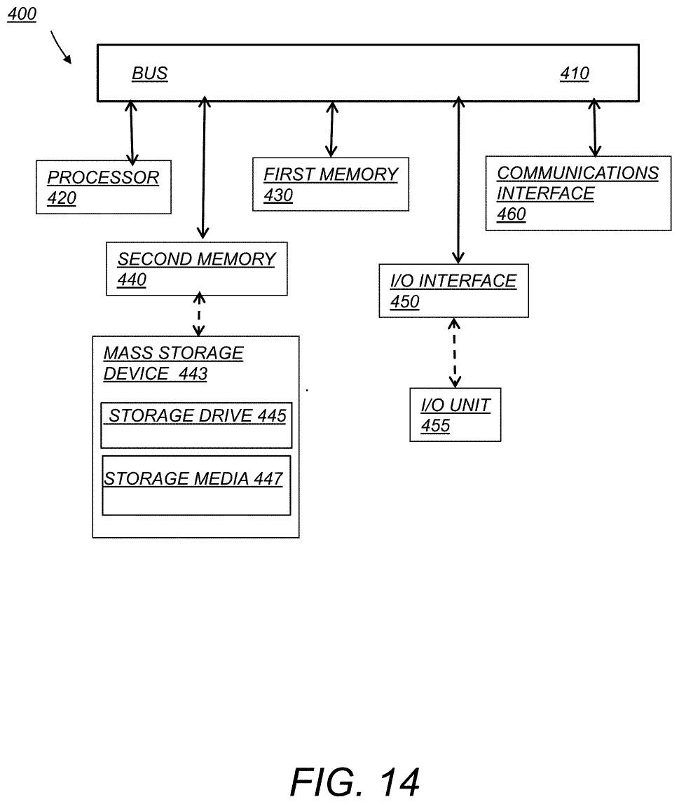

Referring to FIG. 14, an exemplary computer system 400 or network architecture that may be used to implement the system of the present invention includes a processor 420, first memory 430, second memory 440, I/O interface 450 and communications interface 460. All these computer components are connected via a bus 410. One or more processors 420 may be used. Processor 420 may be a special-purpose or a general-purpose processor. As shown in FIG. 14, bus 410 connects the processor 420 to various other components of the computer system 400. Bus 410 may also connect processor 420 to other components (not shown) such as, sensors, and servomechanisms. Bus 410 may also connect the processor 420 to other computer systems. Processor 420 can receive computer code via the bus 410. The term “computer code” includes applications, programs, instructions, signals, and/or data, among others. Processor 420 executes the computer code and may further send the computer code via the bus 410 to other computer systems. One or more computer systems 400 may be used to carry out the computer executable instructions of this invention.

Computer system 400 may further include one or more memories, such as first memory 430 and second memory 440. First memory 430, second memory 440, or a combination thereof function as a computer usable storage medium to store and/or access computer code. The first memory 430 and second memory 440 may be random access memory (RAM), read-only memory (ROM), a mass storage device, or any combination thereof. As shown in FIG. 14, one embodiment of second memory 440 is a mass storage device 443. The mass storage device 443 includes storage drive 445 and storage media 447. Storage media 447 may or may not be removable from the storage drive 445. Mass storage devices 443 with storage media 447 that are removable, otherwise referred to as removable storage media, allow computer code to be transferred to and/or from the computer system 400. Mass storage device 443 may be a Compact Disc Memory, ZIP storage device, tape storage device, magnetic storage device, optical storage device, Micro-Electro-Mechanical Systems (“MEMS”), nanotechnological storage device, floppy storage device, hard disk device, USB drive, among others. Mass storage device 443 may also be program cartridges and cartridge interfaces, removable memory chips (such as an EPROM, or PROM) and associated sockets.

The computer system 400 may further include other means for computer code to be loaded into or removed from the computer system 400, such as the input/output (“I/O”) interface 450 and/or communications interface 460. Both the I/O interface 450 and the communications interface 460 allow computer code to be transferred between the computer system 400 and external devices or webservers including other computer systems. This transfer may be bi-directional or omni-direction to or from the computer system 400. Computer code transferred by the I/O interface 450 and the communications interface 460 are typically in the form of signals, which may be electronic, electromagnetic, optical, or other signals capable of being sent and/or received by the interfaces. These signals may be transmitted via a variety of modes including wire or cable, fiber optics, a phone line, a cellular phone link, infrared (“IR”), and radio frequency (“RF”) link, among others.

The I/O interface 450 may be any connection, wired or wireless, that allows the transfer of computer code. In one example, I/O interface 450 includes an analog or digital audio connection, digital video interface (“DVI”), video graphics adapter (“VGA”), musical instrument digital interface (“MIDI”), parallel connection, PS/2 connection, serial connection, universal serial bus connection (“USB”), IEEE1394 connection, PCMCIA slot and card, among others. In certain embodiments the I/O interface connects to an I/O unit 455 such as a user interface, monitor, speaker, printer, touch screen display, among others. Communications interface 460 may also be used to transfer computer code to computer system 400. Communication interfaces include a modem, network interface (such as an Ethernet card), wired or wireless systems (such as Wi-Fi, Bluetooth, and IR), local area networks, wide area networks, and intranets, among others.

The invention is also directed to computer products, otherwise referred to as computer program products, to provide software that includes computer code to the computer system 400. Processor 420 executes the computer code in order to implement the methods of the present invention. In one example, the methods according to the present invention may be implemented using software that includes the computer code that is loaded into the computer system 400 using a memory 430, 440 such as the mass storage drive 443, or through an I/O interface 450, communications interface 460, or any other interface with the computer system 400. The computer code in conjunction with the computer system 400 may perform any one of, or any combination of, the steps of any of the methods presented herein. The methods according to the present invention may be also performed automatically, or may be invoked by some form of manual intervention.

The computer system 400, or network architecture, of FIG. 14 is provided only for purposes of illustration, such that the present invention is not limited to this specific embodiment.

Several embodiments of the present invention have been described. Nevertheless, it will be understood that various modifications may be made without departing from the spirit and scope of the invention. Accordingly, other embodiments are within the scope of the following claims.

What is claimed is:

1. A system for an augmented reality boating and fishing application comprising:
a client device comprising a client application,
a computing system comprising a server-based application;
a database datastore comprising topobathy data that are presented as data elevation model (DEM) data of a water body;
wherein the client application accesses the server-based application and the database datastore via a network connection;
wherein the server-based application comprises an augmented reality (AR) engine, a computing algorithm, and a rendering engine;
wherein the AR engine receives the DEM data of the water body and environmental factor inputs and uses the computing algorithm to calculate fish probability distributions of various types of fish within the water body;
wherein the rendering engine fuses the calculated fish probability distributions and DEM data and generates an AR composite image that is viewed via the client device.

2. The system of claim 1, wherein the AR composite image is superimposed onto a user's field of view and displayed via a user interface of the client application.

3. The system of claim 1, wherein the client device comprises a camera and the composite image is superimposed onto a user's field of view, as viewed via the camera.

4. The system of claim 1, wherein the client device comprises one of a tablet, a mobile phone or smart glasses.

5. The system of claim 1, wherein the environmental factors comprise at least one of terrain gradients, water visibility, water temperature, tide, wind, current, barometric pressure, light intensity, time of day, date, seasonal variations, local noise, and local traffic.

6. The system of claim 1, wherein the computing algorithm calculates the fish probability distributions of various types of fish within the water body using the environmental factors and set rules and machine-learned rules based on historical data about which species of fish prefer which combinations of the environmental factors.

7. The system of claim 1, wherein the rendering engine receives external data comprising one of instantaneous location GPS data, 5G inputs, orientation compass data and gyroscope data.

8. The system of claim 1, wherein the AR composite image comprises topobathy and bathymetry mapping data, the calculated fish probability distributions, fish location markers, water temperature data, suggested cast depth and suggested fishing equipment and techniques, animated flora and fauna simulated under the water surface in 3D, waypoint and navigation paths between waypoints to optimize fish yield, visualization of boating hazards and navigation dangers.

9. The system of claim 1, wherein the client application comprises a user interface that provides options to drop markers for fishing suggestions, for boating hazards and custom markers within the displayed AR composite image.

10. The system of claim 1, wherein the client application comprises a user interface that provides options to capture digital images, video clips and audio clips of the AR composite image, fish, hazards and objects in the water and upload these digital images, video clips and audio clip to an online website.

11. The system of claim 1, wherein the client application comprises a user interface that provides options to project markers above the surface of the water body within the displayed AR composite image.

12. A computer-implemented method for an augmented reality boating and fishing application comprising:
providing a client device comprising a client application;
providing a computing system comprising a server-based application;
providing a database datastore comprising topobathy data that are presented as data elevation model (DEM) data of a water body;
wherein the client application accesses the server-based application and the database datastore via a network connection;
wherein the server-based application comprises an augmented reality (AR) engine, a computing algorithm, and a rendering engine;
receiving the DEM data of the water body and environmental factor inputs by the AR engine and using the computing algorithm to calculate fish probability distributions of various types of fish within the water body; and
fusing the calculated fish probability distributions and DEM data by the rendering engine and generating an AR composite image that is viewed via the client device.

13. The method of claim 12, wherein the AR composite image is superimposed onto a user's field of view and displayed via a user interface of the client application.

14. The method of claim 12, wherein the client device comprises a camera and the composite image is superimposed onto a user's field of view, as viewed via the camera.

15. The method of claim 12, wherein the client device comprises one of a tablet, a mobile phone or smart glasses.

16. The method of claim 12, wherein the environmental factors comprise at least one of terrain gradients, water visibility, water temperature, tide, wind, current, barometric pressure, light intensity, time of day, date, seasonal variations, local noise, and local traffic.

17. The method of claim 12, wherein the computing algorithm calculates the fish probability distributions of various types of fish within the water body using the environmental factors and set rules and machine-learned rules based on historical data about which species of fish prefer which combinations of the environmental factors.

18. The method of claim 12, wherein the rendering engine receives external data comprising one of instantaneous location GPS data, 5G inputs, orientation compass data and gyroscope data.

19. The method of claim 12, wherein the AR composite image comprises topobathy and bathymetry mapping data, the calculated fish probability distributions, fish location markers, water temperature data, suggested cast depth and suggested fishing equipment and techniques, animated flora and fauna simulated under the water surface in 3D, waypoint and navigation paths between waypoints to optimize fish yield, visualization of boating hazards and navigation dangers.

20. The method of claim 12, wherein the client application comprises a user interface that provides options to drop markers for fishing suggestions, for boating hazards and custom markers within the displayed AR composite image.

21. The method of claim 12, wherein the client application comprises a user interface that provides options to capture digital images, video clips and audio clips of the AR composite image, fish, hazards and objects in the water and upload these digital images, video clips and audio clip to an online website.

22. The method of claim 12, wherein the client application comprises a user interface that provides options to project markers above the surface of the water body within the displayed AR composite image.
